(19) United States
(12) Patent Application Publication
(10) Pub. No.: US 2006/0164660 A1
(43) Pub. Date: Jul. 27, 2006

(54) Method and system for providing predictive paper out status in a print network environment

(76) Inventors: Erin A. Boyd, Longmont, CO (US); Stephen G. Price, Longmont, CO (US)

Correspondence Address: DUFT BORNSEN & FISHMAN, LLP, 1526 SPRUCE STREET, SUITE 302, BOULDER, CO, 80302, US

(21) Appl. No.: 11/044,807

(22) Filed: Jan. 26, 2005

(51) Int. Cl. G06F 3/12

(52) U.S. Cl. 358/1.1

(57) ABSTRACT

A method for providing a predictive out status of a printer is disclosed. The method comprises determining a media requirement of a job for the printer, determining that the proper amount of the media is within the printer, and determining if the job can be printed at the printer based upon the media requirement and the proper amount of media within the printer. In a second aspect, a method in a printer network is disclosed. The method comprises determining if a job can be printed in a default printer. The method further comprises querying all other printers in the network to determine if the job can be printed, if the job can not be printed at the default printer. The method then allows for printing the job at one of the other printers if the job can be printed at the one printer. In a system and method in accordance with the present invention, a predictive message is posted that the printer does not have sufficient paper to complete the task. The advantage to using this approach is posting a very specific error as to the printer's situation and then in enough time to stop the error before it occurs.

### FIELD OF THE INVENTION

The present invention relates generally to printers and more particularly to printers in a print network environment.

### BACKGROUND OF THE INVENTION

In a network print environment there exist few printers and several users (ie computers) who use these printers. Generally these printers are located in a central location away from the user's line of sight. When a particular printer posts it is out of paper the user is informed by the user's operating system, for example a Windows operating system, after the error has occurred. On printers without large data receiving and reading capability, jobs can be lost. On printers with large data receiving and reading capability, the printer could be several jobs behind before a user recognizes a paper out situation and refills the printer accordingly. Currently a driver will post an “error has occurred” with a “retry” or “cancel” option, without knowing what the actual error is. Currently on these systems, the failure would cause the printer to halt the job and record an error entry in the job log. If the printer is not in an operator's line of sight, the operator must read the job log to determine the failure, such as paper out, and then take action.

Accordingly, what is needed is a system and method for allowing enabling a printer to determine whether or not it has the correct media for a job. The system and method should also determine whether the printer has sufficient media to a to carry out the job; and if not, to redirect the printing job to another printer which has adequate supplies for printing the job. The system and method should be cost effective, easily implemented and adaptable to existing print network environments.

The present invention addresses such a need.

### SUMMARY OF THE INVENTION

A method for providing a predictive out status of a printer is disclosed. The method comprises determining a media requirement of a job for the printer, determining that the amount of the media is within the printer, and determining if the job can be printed at the printer based upon the media requirement and the amount of media within the printer.

In a second aspect, a method in a printer network is disclosed. The method comprises determining if a job can be printed in a default printer. The method further comprises querying all other printers in the network to determine if the job can be printed, if the job can not be printed at the default printer. The method then allows for printing the job at one of the other printers if the job can be printed at the one printer.

In a system and method in accordance with the present invention, a predictive message is posted that the printer does not have sufficient paper to complete the task. The advantage to using this approach is that a very specific error is posted as to the printer's situation and the message is posted in enough time to stop the error before it occurs.

Thus, the user can refill the printer prior to other jobs being spooled and a bottleneck situation occurring. In addition, it would allow for printers without sufficient memory for spooling to avoid the loss of jobs. A system and method in accordance with the present invention would increase overall efficiency of printing and prevent possible jamming of paper.

### BRIEF DESCRIPTION OF THE DRAWINGS

FIG. 1 is a block diagram of a network print environment.

FIG. 2 is a flow chart of a first embodiment of a predictive paper out system in accordance with the present invention.

FIG. 3 is a flow chart of a second embodiment of a predictive paper out system in accordance with the present invention.

### DETAILED DESCRIPTION

The present invention relates generally to printers and more particularly to printers in a print network environment. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

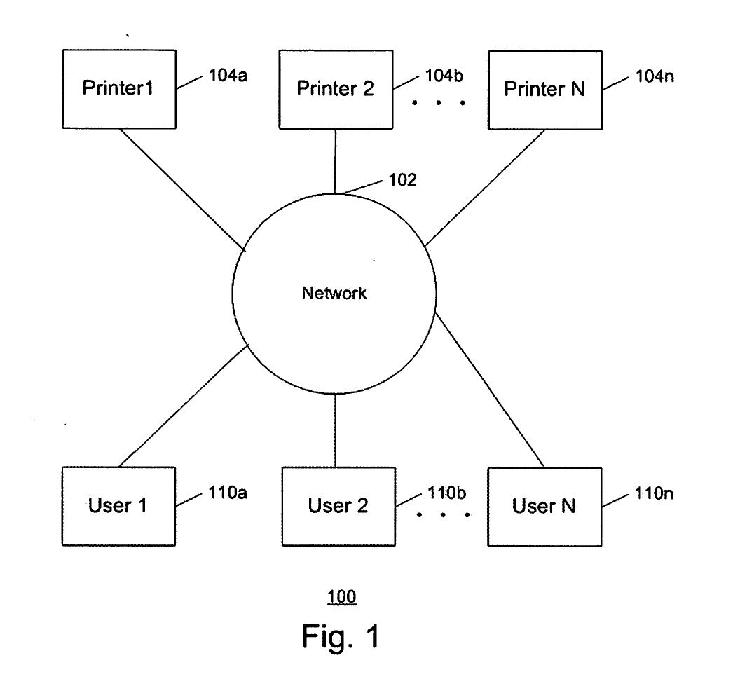

FIG. 1 is a block diagram of a network print environment 100. The print environment 100 includes a network 102. The network 102 could be a private network or a public network. The network 102 could be wireless network or a wired network. A plurality of printers 104a-104n and a plurality of users 110a-110n are coupled to the network. As before mentioned generally the printers 104a-104n are located away from the user's line of sight. When a particular printer posts it is out of paper the user is informed by the user's operating system, for example a Windows operating system, after the error has occurred. On printers without large data receiving and reading capability, jobs can be lost. On printers with large data receiving and reading capability, the printer could be several jobs behind before a user recognizes a paper out situation and refills the printer accordingly. Currently a driver will post an “error has occurred” with a “retry” or “cancel” option, without the actual error.

Typically, the user must read a job log to determine the failure, such as take route and then take action. Oftentimes the operator of a computer may leave the machine, and then come back and find out that the printout did not complete. Therefore, it is desirable to allow for the user to automatically detect and determine that the printer can either print the job at the particular printer or to query other printers to determine if the job can be printed there.

In a system and method in accordance with the present invention, a predictive message is posted that the printer does not have sufficient paper to complete the task. The advantage to using this approach is posting a very specific error as to the printer's situation and then in enough time to stop the error before it occurs.

Thus, the user can refill the printer prior to other jobs being spooled and a bottleneck situation occurring. In addition, it would allow for printers without sufficient memory for spooling to avoid the loss of jobs. A system and method in accordance with the present invention would increase overall efficiency of printing and prevent possible jamming of paper.

To describe the features of the present invention in more detail, refer now to the following description in conjunction with the accompanying figures.

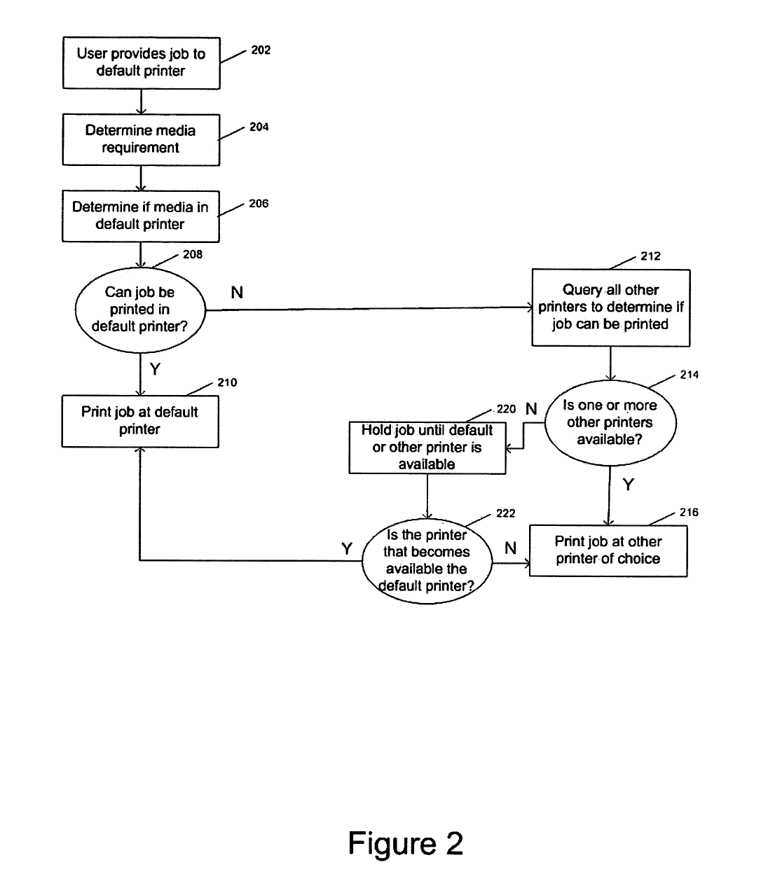

FIG. 2 is a flow chart of a first embodiment of a predictive paper out system in accordance with the present invention. First, a user provides a job to its default printer, via step 202. Next, a media requirement for the job is determined, via step 204.

This task can be accomplished by several means. A new type of classification for media could be developed to allow the user to indicate to the printer the media attributes (color, size, weight of one sheet, and physical attributes (e.g., tabs). Upon loading the media the user can indicate the quantity as prompted by the console.

From this, the printer will be able to accurately determine the exact number of sheets by weighing the media. This encoding system will also streamline the addition of new media to the printer's configuration. Once a job is submitted, the printer will determine if it has the correct specific media type and amount, as indicated in a job ticket (for instance) or by spooling the job, to complete the job.

Thereafter, it is determined if the job can be printed in the default printer, via step 208. If the answer is yes, then the job is printed at the default printer, via step 210. If the answer is no, the other printers in the print environment are queried to determine if the job can be printed at one of the other printers in the print network environment.

Accordingly, when the printer receives a job, it can give accurate confirmation of the specified media type and quantity to complete a job. In the case that the printer does not have the desired media or quantity, the printer will then poll or query other systems on the network for the desired attributes via step 212 and then send a message to the user requesting the job be printed on another device. If the printer receives positive confirmation that one or more other printers are available, via step 214, the printer will then forward the print data to the printer of choice and print the job. On the other hand, if one or more other printers are not available, the job is held until the default printer or the one or more other printers are available, via step 220. It is then determined if the printer that became available is the default printer, via step 222. If the default printer has become available, the job is printed at the default printer. If one or more of the other printers has become available, the job is printed at the other printer of choice, via step 216.

Therefore, in this embodiment, if the other printer is not available the job is held until the other printer is available. However, it may be desirable to have the default printer print the job rather than print at the other printer. For example, the other printer may be a long way away, it may not be exactly what the user wants, etc. Accordingly, it may be desirable to wait for the default printer to be available and then print the job upon the availability of the default printer. To illustrate this feature, refer now to the following description in conjunction with the accompanying figures.

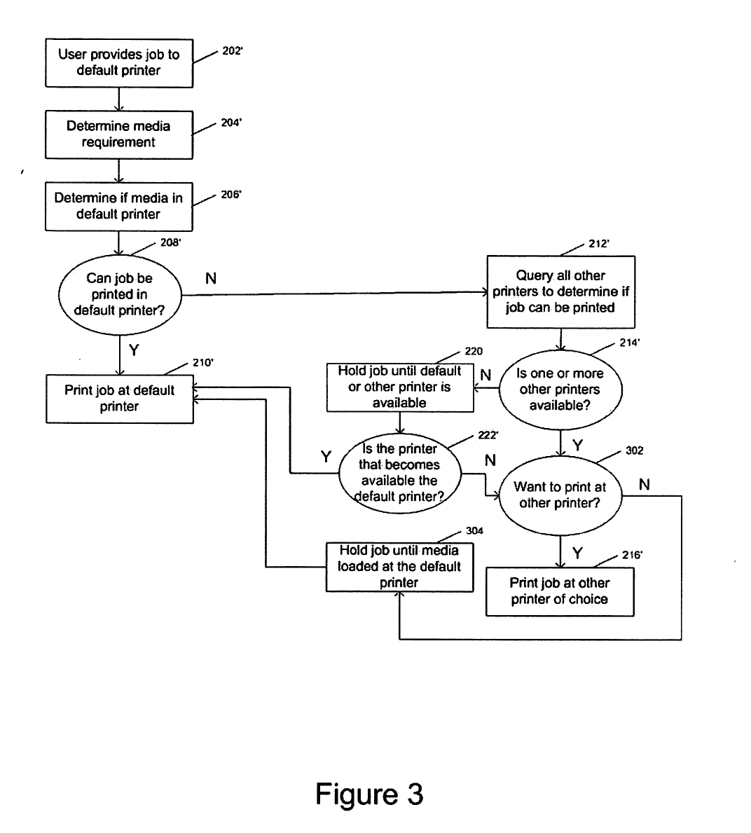

FIG. 3 is a flow chart of a second embodiment of a predictive paper out system in accordance with the present invention. FIG. 3 is similar to FIG. 2 and has many of the same elements. In this embodiment, if it is determined that one or more other printers are available, via step 214′, it is then determined whether the user wants to print the job at the other printer, via step 302. If the user wants to print at the other printer, then the job can be printed at the other printer of choice, via step 216′ as in the embodiment of FIG. 2. If the user does not want to print at the other printer because, for example, it is too far away, then the job is held until the default or other printer becomes available, via step 220. If the printer that becomes available is the default printer, then the print job is completed at the default printer, via step 210′. If the default printer is not available, then the user is queried as to whether they want to print at the other printer, via step 302, if so the job is printed at the other printer of choice, via step 216′. If the user does not want to print at the other printer, via step 302, then the job is held until the media is loaded at the default printer, via step 304, and the job is then printed at the default printer, via step 210′.

Accordingly, a system and method in accordance with the present invention has many advantages over conventional systems. In many applications, the printer would be able to quickly receive and read the job and determine the number of sheets required for printing. Therefore, in a system and method in accordance with the present invention, the printer could then query its engine for the amount of paper and notify the user before the error has occurred that the printer has insufficient paper to complete the task. The user could load the printer as appropriate.

Most printers have sensors indicating how much paper is left in each tray. Methods for this vary from simple tabbed trays to electronic sensors. This could be expanded to also post a notification message for all paper types and appropriate trays that are not currently loaded in the printer that a job ticket might specify and how much paper would be required for each.

This would allow an operator to pre-load the printer without having to read the ticket and decipher the information or wait until an intervention occurs to tell the operator to load paper type X in tray X. Also for printers running from host systems such as PSF/MVS or InfoPrint Manager, it would allow the operator time to properly set up the machine for large lists of non-ticketed jobs. For proprietary environments, a message could be generated on the host system to indicate the same details.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing a predictive out status of a printer comprising:
determining a media requirement of a job for the printer;
determining that the amount of the media is within the printer; and
determining if the job can be printed at the printer based upon the media requirement and the amount of media within the printer.

2. The method of claim 1 wherein a user can indicate to the printer the media attribute to determine the media requirements.

3. The method of claim 2 wherein the printer can determine the amount of media by weighing the media.

4. The method of claim 3 wherein the printer will determine if it has the correct media type and amount as indicated by a job ticket.

5. The method of claim 3 wherein the printer will determine if it has the correct media type amount by receiving and reading the job to complete the job.

6. A method in a printer network comprising:
determining if a job can be printed in a default printer;
querying all other printers in the network to determine if the job can be printed, if the job can not be printed at the default printer; and
printing the job at one of the other printers if job can be printed at the one printer.

7. The method of claim 6 wherein the determining step comprises:
determining a media requirement of the job;
determining if the amount of media is within the default printer; and
determining if the job can be printed at the default printer based upon the media requirement and the amount of media being within the default printer.

8. The method of claim 6 which includes holding the job until one of the other printers are available.

9. The method of claim 6 which includes:
determining if the other printer is available;
determining if it is desirable to print the job at the other printer; and
holding the job until media loaded at the default printer if it is not desirable to print at the other printer.

10. The method of claim 6 which includes:
determining if the other printer is available;
holding the job until the default printer or one of the other printers becomes available if no other printer is available;
determining if the printer that has become available is the default printer or one of the other printers;
printing at the default printer is the default printer has become available; and
printing at one of the other printers if one of the other printers have become available.

11. A computer readable medium containing program instructions for providing a predictive out status of a printer, the program instructions for:
determining a media requirement of a job for the printer;
determining that the amount of the media is within the printer; and
determining if the job can be printed at the printer based upon the media requirement and the amount of media within the printer.

12. The computer readable medium of claim 11 wherein a user can indicate to the printer the media attribute to determine the media requirements.

13. The computer readable medium of claim 12 wherein the printer can determine the proper amount of media by weighing the media.

14. The computer readable medium of claim 13 wherein the printer will determine if it has the correct media type and amount as indicated by a job ticket.

15. The computer readable medium of claim 13 wherein the printer will determine if it has the correct media type amount by receiving and reading the job to complete the job.

16. A computer readable medium containing program instructions in a printer network, the program instructions for:
determining if a job can be printed in a default printer;
querying all other printers in the network to determine if the job can be printed, if the job can not be printed at the default printer; and
printing the job at one of the other printers if job can be printed at the one printer.

17. The computer readable medium of claim 16 wherein the determining step comprises:
determining a media requirement of the job;
determining if the amount of media is within the default printer; and
determining if the job can be printed at the default printer based upon the media requirement and the amount of media being within the default printer.

18. The computer readable medium of claim 16 which includes holding the job until one of the other printers are available.

19. The computer readable medium of claim 16 which includes:
determining if the other printer is available;
determining if it is desirable to print the job at the other printer; and
holding the job until media is loaded at the default printer if it is not desirable to print at the other printer.

20. The computer readable medium of claim 16 which includes:
determining if the other printer is available;
holding the job until the default printer or one of the other printers becomes available if no other printer is available;
determining if the printer that has become available is the default printer or one of the other printers;
printing at the default printer is the default printer has become available; and
printing at one of the other printers if one of the other printers have become available.

21. A printer comprising:
a printing engine; and
a mechanism coupled to the printing engine for determining a media requirement of a job;
a mechanism for indicating that an amount of media is within the printer; and for determining of the correct media type and amount for the job is within the printer.

22. The printer of claim 21 wherein the amount of media is determined by weighing the media.

23. The printer of claim 22 wherein the media requirement is input from a user.

24. The printer of claim 21 wherein the printer will determine if it has the correct media type and amount by a job ticket.

25. The printer of claim 21 wherein the printer will determine if it has the correct media type and amount by receiving and reading the job.
